(19) United States
(12) Patent Application Publication
(10) Pub. No.: US 2025/0126167 A1
(43) Pub. Date: Apr. 17, 2025

(54) FILE TRANSMISSION METHODS, DEVICE, AND STORAGE MEDIUM

(71) Applicant: Beijing Zitiao Network Technology Co., Ltd., Beijing (CN)

(72) Inventors: Jinbo SUN, Beijing (CN); Chenteng WANG, Beijing (CN)

(21) Appl. No.: 18/917,665

(22) Filed: Oct. 16, 2024

(30) Foreign Application Priority Data
Oct. 16, 2023 (CN) 202311340636.6

(51) Int. Cl. H04L 67/06; G06F 9/54; H04L 67/10

(52) U.S. Cl. CPC H04L 67/06

(57) ABSTRACT

File transmission methods, devices and a storage medium are provided. A method is applicable to the transmitter, and includes: obtaining a target file to be transmitted; in response to the target file being a predetermined file corresponding to a file transmission channel, slicing the target file; and transmitting a plurality of sliced target file slices through the file transmission channel to cause a receiver to obtain the target file based on the received target file slices. The file transmission channel is a transmission channel established between a client and a cloud, the cloud comprises a cloud rendering process and a cloud application process, the client and the cloud rendering process are communicatively connected through a predetermined network communication protocol, and the cloud rendering process and the cloud application process are communicatively connected through a predetermined inter-process communication mode.

### CROSS-REFERENCE

This application claims the benefit of Chinese Patent Application No. 202311340636.6 filed on Oct. 16, 2023, entitled “FILE TRANSMISSION METHODS, APPARATUSES, DEVICE, AND STORAGE MEDIUM”, which is hereby incorporated by reference in its entirety.

### FIELD

The embodiment of the present disclosure relates to the technical field of computers, and more particular, to a file transmission method and apparatus, device and a storage medium.

### BACKGROUND

With the rapid development of cloud computing technologies, an application may be placed in a cloud for running, for example, a cloud mobile phone, a cloud game, and the like. An SDK (Software Development Kit) is used to access a client, such that a user can achieve an operation experience close to local delay and image quality across platforms.

Currently, there are two transmission channels between a client and a cloud. One transmission channel is dedicated to transmitting an audio/video stream after cloud rendering. The other transmission channel is used for transmitting an interaction instruction, for example, clicking a viewing instruction. However, in the interaction process between the client and the cloud, some files with a large size are transmitted by using the transmission channel for transmitting the interaction instruction. This will undoubtedly occupy the bandwidth and cause the transmission channel to be congested, thereby affecting the transmission speed of the uplink and downlink interaction instructions and causing a lag of user interaction.

### SUMMARY

In a first aspect, an embodiment of the present disclosure provides a file transmission method, applied to a transmitter, the method including: obtaining a target file to be transmitted; in response to the target file being a predetermined file corresponding to a file transmission channel, slicing the target file; and transmitting a plurality of sliced target file slices through the file transmission channel, to cause a receiver to obtain the target file based on the received target file slices.

The file transmission channel is a transmission channel established between a client and a cloud, the cloud includes a cloud rendering process and a cloud application process, the client and the cloud rendering process are communicatively connected through a predetermined network communication protocol, and the cloud rendering process and the cloud application process are communicatively connected through a predetermined inter-process communication mode.

In a second aspect, an embodiment of the present disclosure provides a file transmission method, applied to a receiver, the method includes: receiving, through a file transmission channel, the plurality of target file slices transmitted by a transmitter, in which the plurality of target file slices are transmitted by the transmitter in response to a target file to be transmitted being a predetermined file corresponding to the file transmission channel and after the target file is sliced; and obtaining the target file based on the received target file slices.

The file transmission channel is a transmission channel established between a client and a cloud, the cloud includes a cloud rendering process and a cloud application process, the client and the cloud rendering process are communicatively connected through a predetermined network communication protocol, and the cloud rendering process and the cloud application process are communicatively connected through a predetermined inter-process communication mode.

In a third aspect, an embodiment of the present disclosure further provides a file transmission apparatus, integrated in a transmitter, the apparatus includes: a target file obtaining module, configured to obtain a target file to be transmitted; a target file slicing module, configured to, in response to the target file being a predetermined file corresponding to a file transmission channel, slice the target file; and a file slice transmitting module, configured to transmit a plurality of sliced target file slices through the file transmission channel to cause a receiver to obtain the target file based on the received target file slices.

The file transmission channel is a transmission channel established between a client and a cloud, the cloud includes a cloud rendering process and a cloud application process, the client and the cloud rendering process are communicatively connected through a predetermined network communication protocol, and the cloud rendering process and the cloud application process are communicatively connected through a predetermined inter-process communication mode.

In a fourth aspect, an embodiment of the present disclosure further provides a file transmission apparatus, integrated in a receiver, the apparatus includes: a file slice receiving module, configured to receive, through a file transmission channel, the plurality of target file slices transmitted by a transmitter, in which the plurality of target file slices are transmitted by the transmitter in response to a target file to be transmitted being a predetermined file corresponding to the file transmission channel and after the target file is sliced; and a target file obtaining module, configured to obtain the target file based on the received target file slices.

The file transmission channel is a transmission channel established between a client and a cloud, the cloud includes a cloud rendering process and a cloud application process, the client and the cloud rendering process are communicatively connected through a predetermined network communication protocol, and the cloud rendering process and the cloud application process are communicatively connected through a predetermined inter-process communication mode.

In a fifth aspect, an embodiment of the present disclosure further provides a file transmission system including a transmitter and a receiver.

The transmitter is configured to implement the file transmission method of the first aspect of the present disclosure. The receiver is configured to implement the file transmission method of the second aspect of the present disclosure.

In a sixth aspect, an embodiment of the present disclosure further provides an electronic device, including: one or more processors; and a storage device configured to store one or more programs. The one or more programs, when executed by the one or more processors, causing the one or more processors to implement the file transmission method according to any of the embodiments of the present disclosure.

In a seventh aspect, an embodiment of the present disclosure further provides a storage medium. The storage medium includes computer-executable instructions that upon execution by a computer processor cause the computer processor to perform the file transmission method according to any of the embodiments of the present disclosure.

### BRIEF DESCRIPTION OF DRAWINGS

The above and other features, advantages, and aspects of various embodiments of the present disclosure will become more apparent from the following detailed description taken in conjunction with the accompanying drawings. Throughout the drawings, the same or similar reference numbers refer to the same or similar elements. It should be understood that, the drawings are schematic, and components and elements are not necessarily drawn to scale.

FIG. 1 illustrates a flowchart of a file transmission method in accordance with embodiments of the present disclosure;

FIG. 2 illustrates a diagram of an example of a file transmission channel in accordance with embodiments of the present disclosure;

FIG. 3 illustrates a flowchart of a file transmission method in accordance with embodiments of the present disclosure;

FIG. 4 illustrates a diagram of an example of a file transmission channel in accordance with embodiments of the present disclosure;

FIG. 5 illustrates a diagram of an example of a file slice and verification in accordance with embodiments of the present disclosure;

FIG. 6 illustrates a flowchart of a file transmission method in accordance with embodiments of the present disclosure;

FIG. 7 illustrates a flowchart of a file transmission method in accordance with embodiments of the present disclosure;

FIG. 8 illustrates a block diagram of a file transmission apparatus in accordance with embodiments of the present disclosure;

FIG. 9 illustrates a block diagram of a file transmission apparatus in accordance with embodiments of the present disclosure;

FIG. 10 illustrates a block diagram of a file transmission system in accordance with embodiments of the present disclosure; and

FIG. 11 illustrates a block diagram of an electronic device in accordance with embodiments of the present disclosure.

### DETAILED DESCRIPTION

Embodiments of the present disclosure will be described in more detail below with reference to the accompanying drawings. While certain embodiments of the present disclosure are illustrated in the drawings, it is to be understood that, the present disclosure may be implemented in various forms, and should not be construed as limited to the embodiments set forth herein, and vice versa. It should be understood that, the drawings and embodiments of the present disclosure are for exemplary purposes only and are not intended to limit the scope of the present disclosure.

It should be understood that, the steps recited in the method embodiments of the present disclosure may be performed in different orders, and/or in parallel. Further, the method embodiments may include additional steps and/or omit performing the illustrated steps. The scope of the present disclosure is not limited in this respect.

As used herein, the term “including” and its variations refer to open inclusion, i.e., “including but not limited to”. The term “based on” is “based at least in part on”. The term “one embodiment” means “at least one embodiment”; the term “another embodiment” means “at least one further embodiment”; the term “some embodiments” means “at least some embodiments”. The relevant definition of other terms will be given below.

It should be noted that, the terms such as “first” and “second” mentioned in the present disclosure are merely used to distinguish different apparatuses, modules, or units, and are not intended to limit the order of functions performed by the apparatuses, modules, or units or the mutual dependency relationship.

It should be noted that, the modification of “a” and “a plurality” mentioned in the present disclosure is illustrative and not limiting, and those skilled in the art should understand that “one or more” should be understood unless the context clearly indicates otherwise.

The names of messages or information interacted between a plurality of devices in embodiments of the present disclosure are for illustrative purposes only, and are not intended to limit the scope of such messages or information.

It may be understood that, the data involved in the technical solution (including but not limited to the data itself, the acquisition or use of the data) should comply with the requirements of the corresponding laws, regulations and relevant provisions.

FIG. 1 illustrates a flowchart of a file transmission method in accordance with embodiments of the present disclosure. The embodiments of the present disclosure can be applicable to the transmission of large-sized files during the interaction between the client and the cloud. The method can be executed by a file transmission apparatus, which can be implemented in the form of software and/or hardware and integrated into the receiver. As illustrated in FIG. 1, the file transmission method may include the followings.

At block S110, a target file to be transmitted is obtained.

The transmitter may be a device transmitting the file, for example, a client or a cloud. The receiver may refer to a device receiving the file, such as a client or a cloud. The client is bidirectional communication with the cloud, such that the client may transmit the file to the cloud, and the cloud may transmit the file to the client. The target file may refer to a local file that needs to be transmitted in the transmitter.

Illustratively, in response to executing the specific business logic, the transmitter may obtain the target file that needs to be transmitted, and actively upload the target file to the receiver. The transmitter may also obtain the target file to be transmitted based on the target file download request transmitted by the receiver, and passively transmit the target file to the receiver.

It should be noted that, in the interaction process between the client and the cloud, the cloud rendered audio and video stream, the interaction instruction, and some large-sized data files may be required to be transmitted.

At block S120, in response to the target file being the predetermined file corresponding to the file transmission channel, the target file is sliced.

The predetermined file may refer to a file that is predetermined and allowed to be transmitted by using the file transmission channel. For example, the predetermined file may include at least one of the following: a file whose file size is greater than a predetermined size, a file whose file type is a predetermined type, and a file that needs to be uploaded based on the interaction instruction. For example, the predetermined file may refer to a data block with a large size, such as an image, a short video, and a game archive file, etc.

Illustratively, the transmitter may detect whether the target file is the predetermined file that needs to be transmitted by using the file transmission channel. In response to detecting that the target file is the predetermined file, the file transmission channel may be allowed for transmission. Then, the target file may be sliced, the large file can be sliced into a plurality of small files, to reduce the amount of data transmitted each time, and improve the file transmission efficiency. In response to detecting that the target file is not the predetermined file, it is determined that the target file is not the file required to be transmitted by the file transmission channel. The original transmission channel can be used for transmission, to ensure the accuracy of transmission.

At block S130, a plurality of sliced target file slices are transmitted through the file transmission channel, to cause a receiver to obtain the target file based on the received target file slices.

The file transmission channel is a transmission channel established between the client and the cloud. The cloud may include a cloud rendering process and a cloud application process. The cloud rendering process may refer to a cloud rendering service program. The cloud rendering process may be used for video streaming, audio and video encoding and pushing, as well as receiving and processing interactive instructions transmitted by the client, and may also be used for receiving and processing files, etc. The cloud application process may refer to a cloud application program or a game instance program, etc.

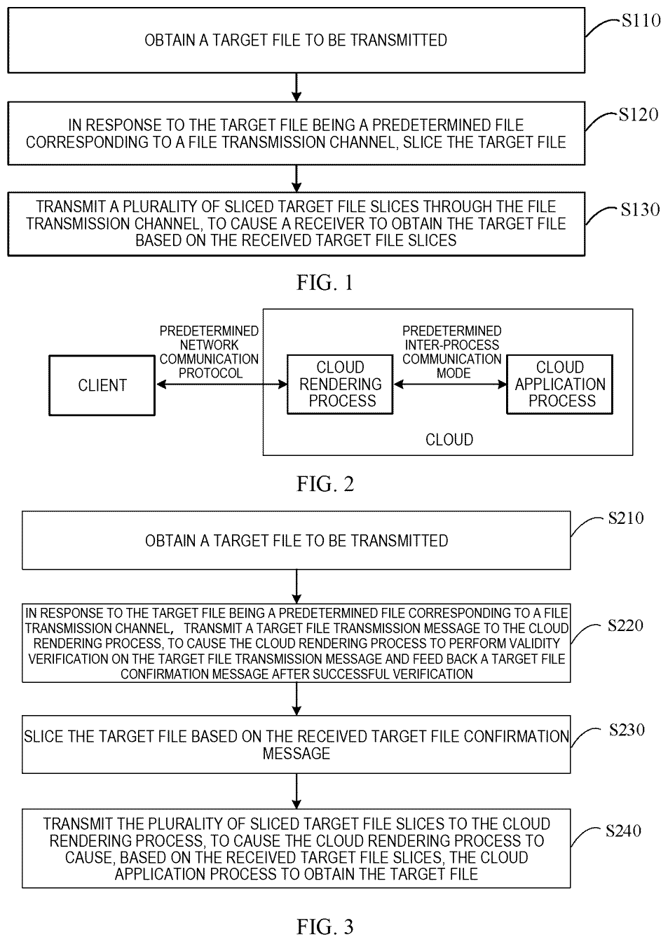

Referring to FIG. 2, in the file transmission channel, the client and the cloud rendering process are communicatively connected through a predetermined network communication protocol. The cloud rendering process and the cloud application process are communicatively connected through a predetermined inter-process communication mode. The predetermined network communication protocol may include, but is not limited to, one of a Hypertext Transfer Protocol (HTTP) or a Transmission Control Protocol based full-duplex communication protocol WebSocket.

The WebSocket protocol has many advantages, such as full duplex, long connection support, low latency, strong compatibility, customizable protocol body, TLS (Transport Layer Security) based connection, and high security, etc. Moreover, by using the WebSocket protocol for communication, the network transmission can be controlled, the network transmission can be more stable, and the bandwidth utilization can be improved. The predetermined inter-process communication mode may include, but is not limited to, one of a Socket communication mode, a Binder communication mode, or a broadcast communication mode.

The Socket is an abstract interface for bidirectional communication ends between the application processes on different hosts in the network. One socket is one end of the process communication on the network, providing a mechanism for the application layer process to exchange data by using the network protocol. The socket is connected to the application process and the network protocol stack, it is the interface for communication of the application through the network protocol, and the interface for interaction between the application and the network protocol stack.

Illustratively, the transmitter may quickly transmit the target file slices to the receiver through the dedicated file transmission channel. The receiver can assemble the received target file slices to obtain the original target file, thereby achieving rapid transmission of the target file, avoiding occupying the original transmission channel, and improving the file transmission efficiency.

For example, when the user wants to use the local image in the client as the image for the cloud application interface, the client may quickly upload the local image to the cloud through the file transmission channel instead of the transmission channel of the interaction instruction. In the cloud, the application interface can be replaced with the local image in the client, and the replaced audio/video stream can be transmitted to the client through the transmission channel of the audio and video stream, thereby improving the file transmission efficiency.

According to the technical solution of the embodiments of the present disclosure, with the client and the cloud rendering process in the cloud being communicatively connected through the predetermined network communication protocol, and the cloud rendering process and the cloud application process in the cloud being communicatively connected through the predetermined inter-process communication mode, a new file transmission channel, dedicated to transmitting the file needing to be transmitted in the interaction process between the client and the cloud, is established between the client and the cloud. In the interaction process between the client and cloud, one is the transmitter, and the other is the receiver. When the transmitter detects that the target file to be transmitted is the predetermined file corresponding to the file transmission channel, the transmitter may slice the target file, and transmit the plurality of sliced target file slices through the file transmission channel. Thus, the slice transmission of the target file can be achieved, and the receiver can obtain the target file more quickly. By transmitting larger files in the interaction process between the client and the cloud through the newly established file transmission channel, the occupation of the original transmission channel can be avoided, the file transmission efficiency can be improved, the interaction delay can be reduced, and the interaction experience can be improved.

FIG. 3 illustrates a flowchart of a file transmission method in accordance with embodiments of the present disclosure. In the embodiments of the present disclosure, the file transmission process in response to the transmitter being the client and the receiver being the cloud are detailed described based on the above embodiments. The explanation of the same or corresponding terms as the above disclosed embodiments will not be repeated here.

As illustrated in FIG. 3, the file transmission method may include the followings.

At block S210, a target file to be transmitted is obtained.

Illustratively, the client may obtain the target file that needs to be uploaded to the cloud.

At block S220, in response to the target file being the predetermined file corresponding to the file transmission channel, a target file transmission message is transmitted to the cloud rendering process, to cause the cloud rendering process to perform validity verification on the target file transmission message and feed back a target file confirmation message after successful verification.

Illustratively, referring to FIG. 2, in response to detecting that the target file is the predetermined file corresponding to the file transmission channel, the client may transmit the target file transmission message to the cloud rendering process through the predetermined network communication protocol. The target file transmission message may include the target file name, the target file size, the target file hash value, the number or the size of slices, the uploaded storage location, etc. After the cloud rendering process receives the target file transmission message, the cloud rendering process may perform validity verification, such as verifying whether there is enough space to store the target file, on the target file transmission message. In response to successful verification, the cloud rendering process can transmit the target file confirmation message to the client, to inform the client that the cloud rendering process is ready to receive the target file.

Illustratively, the cloud rendering process may include a first processing service and a second processing service. The first processing service and the second processing service are communicatively connected through a predetermined intra-process communication mode. The client and the first processing service are communicatively connected through a predetermined network communication protocol. The cloud application process and the second processing service are communicatively connected through a predetermined inter-process communication mode.

The first processing service may refer to a service program used for file transmission with the client in the cloud rendering process. The second processing service may refer to a service program used for file transmission with the cloud application process in the cloud rendering process. The predetermined intra-process communication mode is a mode of communicating within the same program process. The predetermined intra-process communication mode may be, but is not limited to, a function call mode. There is no time delay and loss in the function call mode.

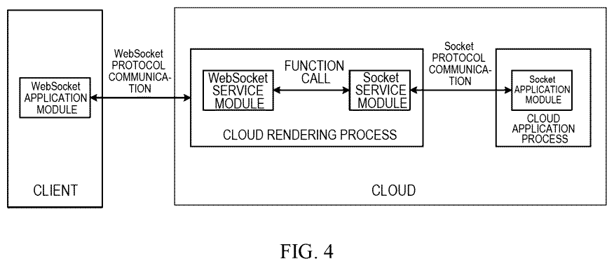

Illustratively, referring to FIG. 4, in response to the predetermined network communication protocol being the WebSocket protocol and the predetermined inter-process communication mode being the Socket communication mode, the first processing service can be the WebSocket service module, and the second processing service can be the Socket service module. Correspondingly, the client can include a WebSocket application module in WebSocket protocol communication with the first processing service, and the cloud application process includes the Socket application module in Socket communication with the second processing service.

Illustratively, referring to FIG. 4, the block S220 may include the followings. In response to the target file being the predetermined file corresponding to the file transmission channel, the client can transmit the target file transmission message to the WebSocket service module in the cloud rendering process through the WebSocket application module, the WebSocket service module can perform validity verification on the received target file transmission message, and feed back the target file confirmation message to the WebSocket application module after successful verification, to inform the client that the cloud rendering process is ready to receive the target file.

At block S230, the target file is sliced based on the received target file confirmation message.

Illustratively, after the client receives the target file confirmation message, the client may start the file slicing process, and slice the target file into a plurality of target file slices. For example, the client may slice the target file based on a preset slice size, to obtain the plurality of sliced target file slices.

At block S240, the plurality of sliced target file slices are transmitted to the cloud rendering process, to cause the cloud rendering process to cause, based on the received target file slices, the cloud application process to obtain the target file.

Illustratively, referring to FIG. 2, the client may transmit the plurality of sliced target file slices sequentially to the cloud rendering process. After the target file slices are received, the cloud rendering process may assemble the received target file slices to obtain the assembled target file. The cloud rendering process can store the obtained target file to the predetermined storage location, and transmit a file transmission success message to the cloud application process, to inform the cloud application process to read the target file at the predetermined storage location, such that the cloud application process can obtain the target file successfully, and execute subsequent business logic based on the obtained target file. After the target file is obtained, the cloud application process can transmit the file obtaining success message to the cloud rendering process, and the cloud rendering process can transmit the file obtaining success message to the client, thereby achieving the upload of the target file in the client.

Illustratively, referring to FIG. 4, the block S240 may include the followings. The client transmits, through the WebSocket application module, the plurality of sliced target file slices sequentially to the WebSocket service module in the cloud rendering process. The WebSocket service module assembles the received target file slices, and stores the assembled target file to the predetermined storage location. The WebSocket service module can transmit the file transmission success message to the Socket service module through the function call mode. The Socket service module can transmit the received file transmission success message to the Socket application module in the cloud application process, such that the cloud application process can read the target file at the predetermined storage location, and execute subsequent business logic based on the obtained target file. After the cloud application process obtains the target file, it can transmit, through the Socket application module, the file obtaining success message to the Socket service module, the Socket service module may transmit the file obtaining success message to the WebSocket service module, and the WebSocket service module transmits, through the WebSocket protocol, the file obtaining success message to the WebSocket application module in the client, thereby achieving the upload of the target file in the client.

Illustratively, the block S240 may include the followings. Transmitting the plurality of sliced target file slices to the cloud rendering process may include: transmitting the plurality of sliced target file slices sequentially to the cloud rendering process, to cause the cloud rendering process to verify each of the received target file slices; continuing to transmit a subsequent target file slice based on a successful slice verification message transmitted by the cloud rendering process; and retransmitting a current target file slice based on a slice verification failure message transmitted by the cloud rendering process.

Illustratively, the client may transmit, through the WebSocket application module, the plurality of target file slices sequentially to the WebSocket service module in the cloud rendering process. The WebSocket service module may verify, based on the hash value (for example, the MD5 value) in the last successfully received slice information, the current target file slice, to ensure the integrity reception of the slice. In response to successful verification, the WebSocket service module may transmit the slice verification success message to the WebSocket application module in the client, and after the slice verification success message is received, the WebSocket application module may continue to transmit the subsequent target file slice. In response to failed verification, the WebSocket application module may transmit the slice verification failure message to the WebSocket application module in the client, and after the slice verification failure message is received, the WebSocket application module may retransmit the current target file slice, until the target file slices are successfully transmitted, thereby ensuring the integrity of the target file transmission.

By transmitting the file slice, high-speed and stable file transmission can be achieved, and the transmission interruption caused by unstable network can be avoided. In order to avoid the packet loss in the file slice transmission process, the hash value of the next file slice is added to the transmitted file slice, such that the integrity of the file slice data transmission can be achieved by the hash value verification.

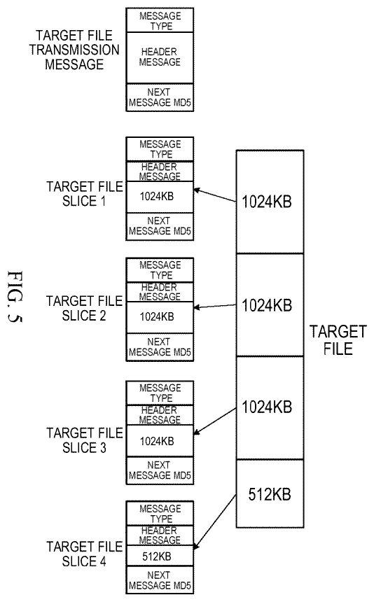

Illustratively, referring to FIG. 5, in response to the size of the target file being 3.5 MB, the target file may be sliced based on the preset slice size 1 MB. For the part less than 1 MB, it is calculated as the remaining part. Thus, 4 target file slices can be obtained, the size of the first three target file slices is 1024 KB, and the size of the last target file slice is 512 KB. In response to transmitting the target file slice, the target file transmission message may be transmitted first, and the message can include three types of information: the message type, the header message, and the MD5 value of the next message. The message type may include a data packet type or an acknowledgment (ACK) message type. The header message may include the target file name, the target file size, the target file hash value, the number or the size of slices, the uploaded storage location, etc. Then, the 4 target file slices can be sequentially transmitted. Each target file slice may also include three types of information. The header message may include the slice index number. When a target file slice is received, the MD5 value corresponding to this target file slice may be determined, and it is determined whether the MD5 value is equal to the MD5 value in the last target file slice. When the two MD5 values are equal, it indicates that the current received target file slice is an integrity slice, the slice verification success message may be fed back, to continue to transmit the subsequent target file slice. When the two MD5 values are not equal, it indicates that the data of the current received target file slice is damaged, and the slice verification failure message may be fed back, to retransmit the current target file slice.

According to the technical solution of the embodiments of the present disclosure, the client transmits the target file transmission message to the cloud rendering process. The cloud rendering process performs validity verification on the target file transmission message, and feeds back the target file confirmation message after successful verification. The client, based on the received target file confirmation message, slices the target file, and transmits the plurality of sliced target file slices to the cloud rendering process, to cause the cloud application process to obtain the target file through the cloud rendering process. Thus, by using the dedicated file transmission channel, the target file in the client is successfully transmitted to the cloud application process, the file transmission efficiency can be improved, the interaction delay can be reduced, and the interaction experience can be improved.

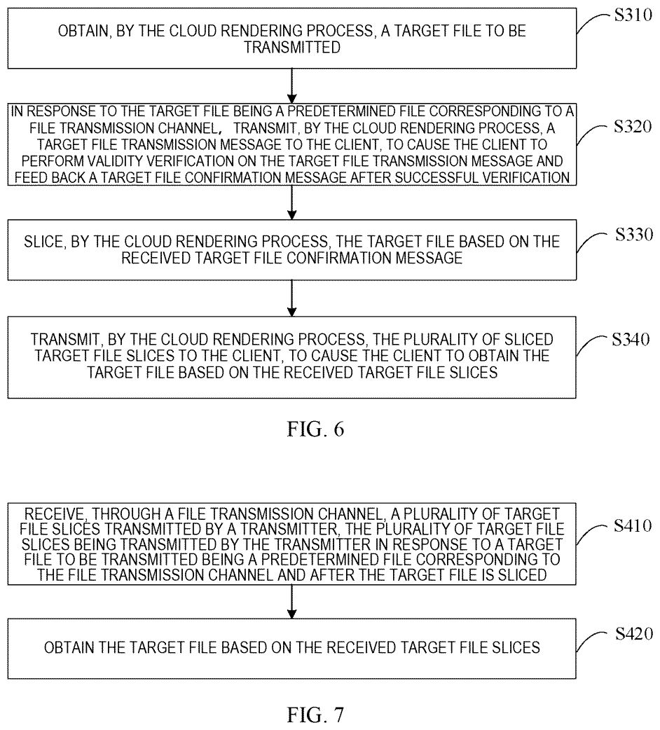

FIG. 6 illustrates a flowchart of a file transmission method in accordance with embodiments of the present disclosure. In the embodiments of the present disclosure, the file transmission process in response to the transmitter being the cloud and the receiver being the client are detailed described based on the above embodiments. The explanation of the same or corresponding terms as the above disclosed embodiments will not be repeated here.

As illustrated in FIG. 6, the file transmission method may include the followings.

At block S310, a target file to be transmitted is obtained by the cloud rendering process.

Illustratively, the cloud rendering process may obtain the target file that needs to be uploaded to the cloud. For example, the cloud rendering process obtains the target file to be transmitted based on the target file download request transmitted by the client. Alternatively, in response to executing the specific business logic, and the cloud application process needs to transmit the target file to the client, the cloud application process may transmit the target file transmission request to the cloud rendering process. The cloud rendering process can obtain the target file to be transmitted based on the target file storage path in the received target file transmission request.

For example, the cloud rendering process may include a first processing service and a second processing service. The block S310 may include: transmitting, by the cloud application process, the target file transmission request to the second processing service; transmitting, by the second processing service, the target file transmission request to the first processing service; and obtaining, by the first processing service, the target file to be transmitted based on the target file storage path in the received target file transmission request.

Referring to FIG. 4, in response to predetermined network communication protocol being the WebSocket protocol and the predetermined inter-process communication mode being the Socket communication mode, the first processing service in the cloud rendering process can be the WebSocket service module, and the second processing service can be the Socket service module. Correspondingly, the client can include the WebSocket application module in WebSocket protocol communication with the first processing service, and the cloud application process can include the Socket application module in Socket communication with the second processing service.

Illustratively, referring to FIG. 4, the block S310 may include the followings. The Socket application module in the cloud application process transmits the target file transmission request to the second processing service (i.e., the Socket service module). The Socket service module transmits the target file transmission request to the first processing service (i.e., the WebSocket service module). Based on the target file storage path in the received target file transmission request, the WebSocket service module can obtain the target file that needs to be transmitted, by the cloud application process, to the client in the running process.

At block S320, in response to the target file being the predetermined file corresponding to the file transmission channel, the target file transmission message is transmitted by the cloud rendering process to the client, to cause the client to perform validity verification on the target file transmission message and feed back the target file confirmation message after successful verification.

Illustratively, referring to FIG. 2, in response to detecting that the target file is the predetermined file corresponding to the file transmission channel, the cloud rendering process transmits the target file transmission message to the client through the predetermined network communication protocol. The target file transmission message may include the target file name, the target file size, the target file hash value, the number or the size of slices, the uploaded storage location, etc. After the target file transmission message is received, the client can perform validity verification, such as verifying whether there is enough space to store the target file, on the target file transmission message. In response to successful verification, the client can transmit the target file confirmation message to the cloud rendering process, to inform the cloud rendering process that the client is ready to receive the target file.

Illustratively, referring to FIG. 4, the block S320 may include the followings. In response to the target file being the predetermined file corresponding to the file transmission channel, the target file transmission message is transmitted, by the WebSocket service module in the cloud rendering process, to the WebSocket application module in the client. The WebSocket application module performs validity verification on the received target file transmission message, and transmits the target file confirmation message to the WebSocket service module after successful verification, to inform the cloud rendering process that the client is ready to receive the target file.

At block S330, the target file is sliced by the cloud rendering process based on the received target file confirmation message.

Illustratively, referring to FIG. 2, after the target file confirmation message is received, the cloud rendering process may start the file slicing process, and slice the target file into a plurality of target file slices. For example, the cloud rendering process may slice the target file based on a preset slice size, to obtain a plurality of sliced target file slices. Illustratively, the first processing service (i.e., the WebSocket service module) in the cloud rendering process can slice the target file.

At block S340, the plurality of sliced target file slices are transmitted by the cloud rendering process to the client, to cause the client to obtain the target file based on the received target file slices.

Illustratively, referring to FIG. 2, the cloud rendering process may transmit the plurality of sliced target file slices sequentially to the client. After the target file slices are received, the client may assemble the received target file slices to obtain the assembled target file. The client can store the obtained target file to the predetermined storage location, such that the client can read the target file at the predetermined storage location. After the target file is obtained, the client can transmit the file obtaining success message to the cloud rendering process, and the cloud rendering process can transmit the file obtaining success message to the cloud application process, thereby achieving the process of transmitting the target file in the cloud application process to the client.

Illustratively, referring to FIG. 4, the block S340 may include the followings. The WebSocket service module transmits the plurality of sliced target file slices sequentially to the WebSocket application module in the client. The WebSocket application module assembles the received target file slices, and stores the assembled target file to the predetermined storage location. After the target file is obtained, the WebSocket application module may transmit the file obtaining success message to the WebSocket service module. The WebSocket service module can transmit the file obtaining success message to the Socket service module through the function call mode. The Socket service module can transmit, through the Socket communication mode, the file obtaining success message to the cloud application process, thereby achieving the process of transmitting the target file in the cloud application process to the client.

Illustratively, the block S340 may include the followings. Transmitting the plurality of sliced target file slices to the client may include: transmitting the plurality of sliced target file slices sequentially to the client, to cause the client to verify each of the received target file slices; continuing to transmit the subsequent target file slice based on the successful slice verification message transmitted by the client; and retransmitting the current target file slice based on the slice verification failure message transmitted by the client. Illustratively, the transmitting process of the target file slice may refer to the above related description, and details are not described herein again.

According to the technical solution of the embodiments of the present disclosure, the target file transmission message is transmitted to the client through the cloud rendering process. The client performs validity verification on the target file transmission message, and feeds back the target file confirmation message after successful verification. The cloud rendering process slices the target file based on the received target file confirmation message, and transmits the plurality of sliced target file slices to the client, to cause the client to obtain the target file. Thus, by using the dedicated file transmission channel, the target file in the cloud is successfully transmitted to the client, the file transmission efficiency can be improved, the interaction delay can be reduced, and the interaction experience can be improved.

FIG. 7 illustrates a flowchart of a file transmission method in accordance with embodiments of the present disclosure. The embodiments of the present disclosure can be applicable to the transmission of large-sized files during the interaction between the client and the cloud. The method can be executed by a file transmission apparatus, which can be implemented in the form of software and/or hardware and integrated into the receiver. As illustrated in FIG. 7, the file transmission method may include the followings.

At block S410, a plurality of target file slices, transmitted by the transmitter through the file transmission channel, are received. The plurality of target file slices are transmitted by the transmitter in response to the target file to be transmitted being the predetermined file corresponding to the file transmission channel and after the target file is sliced.

Referring to FIG. 2, the file transmission channel is the transmission channel established between the client and the cloud. The cloud includes the cloud rendering process and the cloud application process. The client and the cloud rendering process are communicatively connected through the predetermined network communication protocol.

The cloud rendering process and the cloud application process are communicatively connected through the predetermined inter-process communication mode.

Illustratively, the transmitter may quickly transmit the target file slices to the receiver through the dedicated file transmission channel. For example, the client may quickly transmit the target file slices to the cloud rendering process through the dedicated file transmission channel. Alternatively, the cloud rendering process may quickly transmit the target file slices to the client through the dedicated file transmission channel.

At block S420, target file is obtained based on the received target file slices.

Illustratively, the receiver can assemble the received target file slices to obtain the original target file, thereby achieving rapid transmission of the target file, avoiding occupying the original transmission channel, and improving file transmission efficiency.

Illustratively, in response to the transmitter being the client and the receiver being the cloud, the block S420 may include: storing, by the cloud rendering process, a received target file slice into a first cache queue, and assembling the target file slices in the first cache queue after the target file slices are received, to obtain an assembled target file; storing, by the cloud rendering process, the target file to a predetermined storage location, and transmitting a file transmission success message to the cloud application process; and obtaining, by the cloud application process, the target file from the predetermined storage location based on the received file transmission success message.

Illustratively, the cloud rendering process can perform, with the first cache queue, slice caching according to the slice receiving sequence, and after the target file slices are received, retrieve the target file slices from the first cache queue and assemble them, thereby improving the accuracy of file assembly.

Illustratively, referring to FIG. 4, the block S420 may include the followings. The client transmits, through the WebSocket application module, the plurality of sliced target file slices sequentially to the WebSocket service module in the cloud rendering process. The WebSocket service module stores the received target file slices in the first cache queue, and after the target file slices are received, assembles the target file slices in the first cache queue, and stores the assembled target file to the predetermined storage location. The WebSocket service module transmits the file transmission success message to the Socket service module through the function call mode. The Socket service module then transmits the received file transmission success message to the Socket application module in the cloud application process, to inform the cloud application process to read the target file from the predetermined storage location.

Illustratively, in response to the transmitter being the cloud and the receiver being the client, the block S420 may include: storing, by the client, the received target file slice into a second cache queue, and assembling the target file slices in the second cache queue after the target file slices are received, to obtain the assembled target file; and storing, by the client, the target file to the predetermined storage location, to cause the client to obtain the target file from the predetermined storage location.

Illustratively, the client can perform, with the second cache queue, slice caching according to the slice receiving sequence, and after the target file slices are received, retrieve the target file slices from the second cache queue and assemble them, thereby improving the accuracy of file assembly.

Illustratively, referring to FIG. 4, the block S420 may include the followings. The WebSocket service module transmits the plurality of sliced target file slices sequentially to the WebSocket application module in the client. The WebSocket application module stores the received target file slices in the second cache queue, and after the target file slices are received, assembles the target file slices in the second cache queue, and stores the assembled target file to the predetermined storage location. The WebSocket application module can transmit the file transmission success message to the client through the intra-process function call mode, to inform the client to read the target file from the predetermined storage location.

According to the technical solution of the embodiments of the present disclosure, with the client and the cloud rendering process in the cloud being communicatively connected through the predetermined network communication protocol, and the cloud rendering process and the cloud application process in the cloud being communicatively connected through the predetermined inter-process communication mode, a new file transmission channel, dedicated to transmitting the file needing to be transmitted in the interaction process between the client and the cloud, is established between the client and the cloud. In the interaction process between the client and cloud, one is the transmitter, and the other is the receiver. When the transmitter detects that the target file to be transmitted is the predetermined file corresponding to the file transmission channel, the transmitter may slice the target file, and transmit the plurality of sliced target file slices through the file transmission channel. Thus, the slice transmission of the target file can be achieved, and the receiver can obtain the target file more quickly. By transmitting larger files in the interaction process between the client and the cloud through the newly established file transmission channel, the occupation of the original transmission channel can be avoided, the file transmission efficiency can be improved, the interaction delay can be reduced, and the interaction experience can be improved.

The embodiments of the file transmission apparatus of the present disclosure will be described below. The apparatus and the method of the above embodiments belong to the same inventive concept, and details not described in detail in the embodiments of the file transmission apparatus may refer to the above embodiments.

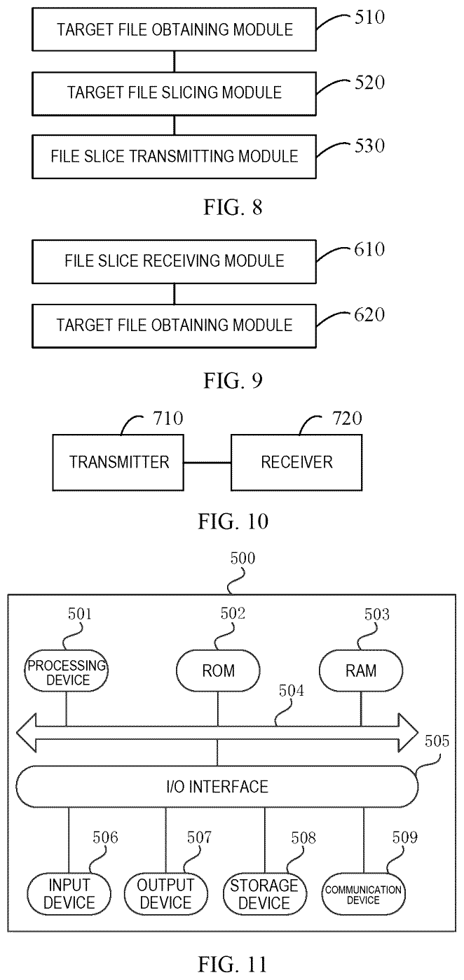

FIG. 8 illustrates a block diagram of a file transmission apparatus in accordance with embodiments of the present disclosure. As illustrated in FIG. 8, the apparatus is integrated into the transmitter, and includes a target file acquisition module 510, a target file slicing module 520, and a file slicing transmission module 530.

The target file obtaining module 510 is configured to obtain a target file to be transmitted. The target file slicing module 520 is configured to, in response to the target file being a predetermined file corresponding to a file transmission channel, slice the target file. The file slice transmitting module 530 is configured to transmit the plurality of sliced target file slice through the file transmission channel, to cause a receiver to obtain the target file based on the received target file slices. The file transmission channel is a transmission channel established between a client and a cloud, the cloud includes a cloud rendering process and a cloud application process, the client and the cloud rendering process are communicatively connected through a predetermined network communication protocol, and the cloud rendering process and the cloud application process are communicatively connected through a predetermined inter-process communication mode.

According to the technical solution of the embodiments of the present disclosure, with the client and the cloud rendering process in the cloud being communicatively connected through the predetermined network communication protocol, and the cloud rendering process and the cloud application process in the cloud being communicatively connected through the predetermined inter-process communication mode, a new file transmission channel, dedicated to transmitting the file needing to be transmitted in the interaction process between the client and the cloud, is established between the client and the cloud. In the interaction process between the client and cloud, one is the transmitter, and the other is the receiver. When the transmitter detects that the target file to be transmitted is the predetermined file corresponding to the file transmission channel, the transmitter may slice the target file, and transmit the plurality of sliced target file slices through the file transmission channel. Thus, the slice transmission of the target file can be achieved, and the receiver can obtain the target file more quickly. By transmitting larger files in the interaction process between the client and the cloud through the newly established file transmission channel, the occupation of the original transmission channel can be avoided, the file transmission efficiency can be improved, the interaction delay can be reduced, and the interaction experience can be improved.

Based on the above technical solution, the predetermined network communication protocol includes one of a Hypertext Transfer Protocol or a Transmission Control Protocol based full-duplex communication protocol.

The predetermined inter-process communication mode includes one of the Socket communication mode, the binder communication mode, or the broadcast communication mode.

According to the above technical solutions, in response to the transmitter being the client and the receiver being the cloud, the target file slicing module 520 is further configured to: transmit a target file transmission message to the cloud rendering process, to cause the cloud rendering process to perform validity verification on the target file transmission message and feed back a target file confirmation message after successful verification; and slice the target file based on the received target file confirmation message.

According to the above technical solutions, in response to the transmitter being the client and the receiver being the cloud, the file slice transmitting module 530 is further configured to: transmit a plurality of sliced target file slices to the cloud rendering process, to cause the cloud rendering process to cause, based on the received target file slices, the cloud application process to obtain the target file.

According to the above technical solutions, in response to the transmitter being the client and the receiver being the cloud, the file slice transmitting module 530 is further configured to: transmit the plurality of sliced target file slices sequentially to the cloud rendering process, to cause the cloud rendering process to verify each of the received target file slices; continue to transmit a subsequent target file slice based on a successful slice verification message transmitted by the cloud rendering process; and retransmit a current target file slice based on a slice verification failure message transmitted by the cloud rendering process.

According to the above technical solutions, in response to the transmitter being the cloud and the receiver being client, the target file slicing module 520 is further configured to: transmit, by the cloud rendering process, a target file transmission message to the client, to cause the client to perform validity verification on the target file transmission message and feed back a target file confirmation message after successful verification; and slice, by the cloud rendering process, the target file based on the received target file confirmation message.

According to the above technical solutions, the cloud rendering process includes: a first processing service and a second processing service. The first processing service and the second processing service are communicatively connected through a predetermined intra-process communication mode. The client and the first processing service are communicatively connected through a predetermined network communication protocol. The cloud application process and the second processing service are communicatively connected through a predetermined inter-process communication mode.

Based on the above technical solutions, in response to the transmitter being the cloud and the receiver being client, the target file obtaining module 510 is further configured to: transmit, by the cloud application process, a target file transmission request to the second processing service; transmit, by the second processing service, the target file transmission request to the first processing service; and obtain, by the first processing service, the target file to be transmitted based on the target file storage path in the received target file transmission request.

The file transmission apparatus according to the embodiments of the present disclosure may perform the file transmission method applied to the transmitter according to any embodiment of the present disclosure, and has functional modules and beneficial effects corresponding to the method.

FIG. 9 illustrates a block diagram of a file transmission apparatus in accordance with embodiments of the present disclosure. As illustrated in FIG. 9, the apparatus is integrated into the receiver, and includes a file slice receiving module 610 and a target file obtaining module 620.

The file slice receiving module 610 is configured to receive, through a file transmission channel, the plurality of target file slices transmitted by a transmitter. The plurality of target file slices are transmitted by the transmitter in response to a target file to be transmitted being a predetermined file corresponding to the file transmission channel and after the target file is sliced. The target file obtaining module 620 is configured to obtain the target file based on the received target file slices. The file transmission channel is a transmission channel established between a client and a cloud, the cloud includes a cloud rendering process and a cloud application process.

The client and the cloud rendering process are communicatively connected through a predetermined network communication protocol, and the cloud rendering process and the cloud application process are communicatively connected through a predetermined inter-process communication mode.

According to the technical solution of the embodiments of the present disclosure, with the client and the cloud rendering process in the cloud being communicatively connected through the predetermined network communication protocol, and the cloud rendering process and the cloud application process in the cloud being communicatively connected through the predetermined inter-process communication mode, a new file transmission channel, dedicated to transmitting the file needing to be transmitted in the interaction process between the client and the cloud, is established between the client and the cloud. In the interaction process between the client and cloud, one is the transmitter, and the other is the receiver. When the transmitter detects that the target file to be transmitted is the predetermined file corresponding to the file transmission channel, the transmitter may slice the target file, and transmit the plurality of sliced target file slices through the file transmission channel. Thus, the slice transmission of the target file can be achieved, and the receiver can obtain the target file more quickly. By transmitting larger files in the interaction process between the client and the cloud through the newly established file transmission channel, the occupation of the original transmission channel can be avoided, the file transmission efficiency can be improved, the interaction delay can be reduced, and the interaction experience can be improved.

According to the above technical solution, in response to the transmitter being the client and the receiver being the cloud, the target file obtaining module 620 is further configured to: store, by the cloud rendering process, a received target file slice into a first cache queue, and assemble the target file slices in the first cache queue after the target file slices are received, to obtain an assembled target file; store, by the cloud rendering process, the target file to a predetermined storage location, and transmit a file transmission success message to the cloud application process; and obtain, by the cloud application process, the target file from the predetermined storage location based on the received file transmission success message.

According to the above technical solutions, in response to the transmitter being the cloud and the receiver being client, the target file obtaining module 620 is further configured to: store, by the client, a received target file slice into a second cache queue, and assemble the target file slices in the second cache queue after the target file slices are received, to obtain an assembled target file; and store, by the client, the target file to a predetermined storage location, to cause the client to obtain the target file from the predetermined storage location.

The file transmission apparatus according to the embodiments of the present disclosure may perform the file transmission method applied to the receiver according to any embodiment of the present disclosure, and has functional modules and beneficial effects corresponding to the method.

It should be noted that the units and modules included in the above apparatus are only divided according to the function logic, but are not limited to the above division, as long as the corresponding functions can be implemented. In addition, the specific names of the functional units are merely for ease of distinguishing, and are not intended to limit the protection scope of the embodiments of the present disclosure.

FIG. 10 illustrates a block diagram of a file transmission system in accordance with embodiments of the present disclosure. The embodiments of the present disclosure can be applicable to the transmission of large-sized files during the interaction between the client and the cloud. As illustrated in FIG. 10, the system may include a transmitter 710 and a receiver 720.

The transmitter 710 is configured to implement the file transmission method applied to the transmitter according to any embodiment of the present. The receiver 720 is configured to implement the file transmission method applied to the receiver according to any embodiment of the present disclosure.

The transmitter 710 may be a device transmitting the file, such as a client or a cloud. The receiver 720 may refer to a device receiving a file, such as a client or a cloud. Bi-directional communication can be performed between the client 710 and the cloud 720, such that the client 710 may transmit the file to the cloud 720, and the cloud 720 may also transmit the file to the client 710.

According to the technical solution of the embodiments of the present disclosure, with the client and the cloud rendering process in the cloud being communicatively connected through the predetermined network communication protocol, and the cloud rendering process and the cloud application process in the cloud being communicatively connected through the predetermined inter-process communication mode, a new file transmission channel, dedicated to transmitting the file needing to be transmitted in the interaction process between the client and the cloud, is established between the client and the cloud. In the interaction process between the client and cloud, one is the transmitter, and the other is the receiver. When the transmitter detects that the target file to be transmitted is the predetermined file corresponding to the file transmission channel, the transmitter may slice the target file, and transmit the plurality of sliced target file slices through the file transmission channel. Thus, the slice transmission of the target file can be achieved, and the receiver can obtain the target file more quickly. By transmitting larger files in the interaction process between the client and the cloud through the newly established file transmission channel, the occupation of the original transmission channel can be avoided, the file transmission efficiency can be improved, the interaction delay can be reduced, and the interaction experience can be improved.

FIG. 11 illustrates a block diagram of an electronic device in accordance with embodiments of the present disclosure. With reference to FIG. 11, it illustrates a schematic diagram of an electronic device (such as the terminal device or server in FIG. 11) suitable for implementing the embodiments of the present disclosure. The terminal device in the embodiments of the present disclosure may include, but is not limited to, a mobile terminal such as a mobile phone, a notebook computer, a digital broadcast receiver, a PDA (personal digital assistant), a PAD (tablet computer), a PMP (portable multimedia player), an in-vehicle terminal (for example, an in-vehicle navigation terminal), and a fixed terminal such as a digital TV, a desktop computer, or the like. The electronic device illustrated in FIG. 11 is merely an example, and should not impose any limitation on the functions and scope of use of the embodiments of the present disclosure.

As illustrated in FIG. 11, the electronic device 500 may include a processing device 501 (for example, a central processing unit, a graphics processor, etc.), which may perform various appropriate actions and processing according to a program stored in a read-only memory (ROM) 502 or a program loaded into a random access memory (RAM) 503 from a storage device 508. In the RAM 503, various programs and data required by the operation of the electronic device 500 are also stored. The processing device 501, the ROM 502, and the RAM 503 are connected to each other through a bus 504. The input/output (I/O) interface 505 is also connected to the bus 504.

Generally, the following devices may be connected to the I/O interface 505: an input device 506 including, for example, a touch screen, a touchpad, a keyboard, a mouse, a camera, a microphone, an accelerometer, a gyroscope, etc.; an output device 507 including, for example, a liquid crystal display (LCD), a speaker, a vibrator, etc.; a storage device 508 including, for example, a magnetic tape, a hard disk, etc.; and a communication device 509. The communication device 509 may allow the electronic device 500 to communicate wirelessly or wired with other devices to exchange data. While FIG. 11 shows an electronic device 500 having various devices, it should be understood that, it is not required to implement or have all illustrated devices. More or fewer devices may alternatively be implemented or provided.

In particular, according to an embodiment of the present disclosure, the process described above with reference to the flowchart may be implemented as a computer software program. For example, embodiments of the present disclosure include a computer program product including a computer program embodied on a non-transitory computer readable medium, the computer program including program code for performing the method illustrated in the flowchart. In such embodiments, the computer program may be downloaded and installed from the network through the communication device 509, or installed from the storage device 508, or from the ROM 502. When the computer program is executed by the processing apparatus 501, the above functions defined in the method of the embodiments of the present disclosure are performed.

The names of messages or information interaction between a plurality of devices in embodiments of the present disclosure are for illustrative purposes only and are not intended to limit the scope of such messages or information.

The electronic device provided by the embodiments of the present disclosure and the file transmission method according to the above embodiments belong to the same inventive concept, and technical details not described in detail in this embodiment may refer to the above embodiments, and this embodiment has the same beneficial effects as the above embodiments.

Embodiment of the present disclosure provides a computer storage medium including a computer program stored thereon, the program, when executed by a processor, cause the computer processor to perform the file transmission method according to the above embodiments.

It should be noted that the computer-readable medium described above may be a computer readable signal medium, a computer readable storage medium, or any combination of the above two. The computer-readable storage medium may be, for example, but not limited to, an electrical, magnetic, optical, electromagnetic, infrared, or semiconductor system, device, or device, or any combination thereof. More specific examples of computer-readable storage media may include, but are not limited to, an electrical connection having one or more wires, a portable computer diskette, a hard disk, a random access memory (RAM), a read-only memory (ROM), an erasable programmable read-only memory (EPROM or Flash memory), an optical fiber, a portable compact disk read-only memory (CD-ROM), an optical storage device, a magnetic storage device, or any suitable combination of the above.

In the present disclosure, a computer-readable storage medium may be any tangible medium containing or storing a program that may be used by or in connection with an instruction execution system, apparatus, or device. In the present disclosure, a computer readable signal medium may include a data signal propagated in baseband or as part of a carrier, where the computer readable program code is carried. Such propagated data signals may take a variety of forms including, but not limited to, electromagnetic signals, optical signals, or any suitable combination of the above. The computer readable signal medium may also be any computer readable medium other than a computer readable storage medium that may transmit, propagate, or transmit a program for use by or in connection with an instruction execution system, apparatus, or device. The program code included in the computer-readable medium may be transmitted with any suitable medium, including, but not limited to, wires, optical cables, RF (radio frequency), and the like, or any suitable combination of the above.

In some implementations, the client and the server may communicate using any currently known or future developed network protocol, such as HTTP (Hyper Text Transfer Protocol), and may be interconnected with any form or medium of digital data communication (e.g., a communication network). Examples of communication networks include local area networks (LAN), wide area networks (WAN), internets (e.g., the Internet), and peer-to-peer networks (e.g., ad hoc peer-to-peer networks), as well as any currently known or future developed networks.

The computer-readable medium described above may be included in the electronic device; or may be separately present without being assembled into the electronic device.

The computer readable medium can include one or more programs, and when the one or more programs are executed by the electronic device, the electronic device is caused to: obtain a target file to be transmitted; in response to the target file being a predetermined file corresponding to a file transmission channel, slice the target file; and transmit a plurality of sliced target file slices through the file transmission channel, to cause the receiver to obtain the target file based on the received target file slices. The file transmission channel is a transmission channel established between a client and a cloud, and the cloud includes a cloud rendering process and a cloud application process. The client and the cloud rendering process are communicatively connected through a predetermined network communication protocol, and the cloud rendering process and the cloud application process are communicatively connected through a predetermined inter-process communication mode.

Alternatively, the computer-readable medium includes one or more programs, and when the one or more programs are executed by the electronic device, the electronic device is caused to: receive, through a file transmission channel, the plurality of target file slices transmitted by a transmitter, in which the plurality of target file slices are transmitted by the transmitter in response to a target file to be transmitted being a predetermined file corresponding to the file transmission channel and after the target file is sliced; and obtain the target file based on the received target file slices. The file transmission channel is a transmission channel established between a client and a cloud, the cloud includes a cloud rendering process and a cloud application process. The client and the cloud rendering process are communicatively connected through a predetermined network communication protocol, and the cloud rendering process and the cloud application process are communicatively connected through a predetermined inter-process communication mode.

Computer program code for performing the operations of the present disclosure may be written in one or more programming languages, including, but not limited to, object oriented programming languages such as Java, Smalltalk, C++, and conventional procedural programming languages, such as the “C” language or similar programming languages. The program code may execute entirely on a user computer, partially on a user computer, as a stand-alone software package, partially on a user computer, partially on a remote computer, or entirely on a remote computer or server. In the case of a remote computer, the remote computer may be connected to the user computer through any kind of network, including a local area network (LAN) or a wide area network (WAN), or may be connected to an external computer (e.g., connected through the Internet using an Internet service provider).

The flowcharts and block diagrams in the figures illustrate architecture, functionality, and operation of possible implementations of systems, methods, and computer program products according to various embodiments of the present disclosure. In this regard, each block in the flowchart or block diagram may represent a module, program segment, or portion of code that includes one or more executable instructions for implementing the specified logical function. It should also be noted that in some alternative implementations, the functions noted in the blocks may also occur in a different order than that illustrated in the figures. For example, two consecutively represented blocks may actually be performed substantially in parallel, which may sometimes be performed in the reverse order, depending on the functionality involved. It is also noted that each block in the block diagrams and/or flowcharts, as well as combinations of blocks in the block diagrams and/or flowcharts, may be implemented with a dedicated hardware-based system that performs the specified functions or operations, or may be implemented in a combination of dedicated hardware and computer instructions.

The units involved in the embodiments of the present disclosure may be implemented in software, or may be implemented in hardware. For example, the first obtaining unit may be further described as: obtaining at least two units of Internet Protocol addresses.

The functions described above may be performed, at least in part, by one or more hardware logic components. For example, without limitation, exemplary types of hardware logic components that may be used can include: field programmable gate arrays (FPGAs), application specific integrated circuits (ASICs), application specific standard products (ASSPs), system-on-a-chip (SOCs), complex programmable logic devices (CPLDs), and the like.

In the context of the present disclosure, a machine-readable medium may be a tangible medium that may contain or store a program for use by or in connection with an instruction execution system, apparatus, or device.

The machine-readable medium may be a machine-readable signal medium or a machine-readable storage medium. The machine-readable medium may include, but is not limited to, electronic, magnetic, optical, electromagnetic, infrared, or semiconductor systems, devices, or devices, or any suitable combination of the above. More specific examples of machine-readable storage media may include electrical connections based on one or more lines, portable computer disks, hard disks, random access memory (RAM), read-only memory (ROM), erasable programmable read-only memory (EPROM or Flash memory), optical fibers, portable compact disc read-only memory (CD-ROM), optical storage devices, magnetic storage devices, or any suitable combination of the above.

According to one or more embodiments of the present disclosure, a file transmission method according to Example 1 of the present disclosure is provided. The method can be applied to a transmitter, and include: obtaining a target file to be transmitted; in response to the target file being a predetermined file corresponding to a file transmission channel, slicing the target file; and transmitting a plurality of sliced target file slices through the file transmission channel, to cause a receiver to obtain the target file based on the received target file slices.

The file transmission channel is a transmission channel established between a client and a cloud, the cloud includes a cloud rendering process and a cloud application process. The client and the cloud rendering process are communicatively connected through a predetermined network communication protocol, and the cloud rendering process and the cloud application process are communicatively connected through a predetermined inter-process communication mode.

According to one or more embodiments of the present disclosure, the file transmission method according to Example 2 of the present disclosure further include the followings.

In at least one embodiments, the predetermined network communication protocol includes one of a Hypertext Transfer Protocol or a Transmission Control Protocol based full-duplex communication protocol. The predetermined inter-process communication mode includes one of the Socket communication mode, the Binder communication mode, or the broadcast communication mode.

According to one or more embodiments of the present disclosure, the file transmission method according to Example 3 of the present disclosure further includes the followings.

In at least one embodiments, in response to the transmitter being the client and the receiver being the cloud, slicing the target file includes: transmitting a target file transmission message to the cloud rendering process, to cause the cloud rendering process to perform validity verification on the target file transmission message and feed back a target file confirmation message after successful verification; and slicing the target file based on the received target file confirmation message.

According to one or more embodiments of the present disclosure, the file transmission method according to Example 4 of the present disclosure further includes the followings.

In at least one embodiments, in response to the transmitter being the client and the receiver being the cloud, transmitting the plurality of sliced target file slices through the file transmission channel, to cause the receiver to obtain the target file based on the received target file slices includes: transmitting the plurality of sliced target file slices to the cloud rendering process, to cause the cloud rendering process to cause, based on the received target file slices, the cloud application process to obtain the target file.

According to one or more embodiments of the present disclosure, the file transmission method according to Example 5 of the present disclosure further includes the followings.

In at least one embodiments, transmitting the plurality of sliced target file slice to the cloud rendering process includes: transmitting the plurality of sliced target file slices sequentially to the cloud rendering process, to cause the cloud rendering process to verify each of the received target file slices; continuing to transmit a subsequent target file slice based on a successful slice verification message transmitted by the cloud rendering process; and retransmitting a current target file slice based on a slice verification failure message transmitted by the cloud rendering process.

According to one or more embodiments of the present disclosure, the file transmission method according to Example 6 of the present disclosure further includes the followings.

In at least one embodiments, in response to the transmitter being the cloud and the receiver being client, slicing the target file includes: transmitting, by the cloud rendering process, a target file transmission message to the client, to cause the client to perform validity verification on the target file transmission message and feed back a target file confirmation message after successful verification; and slicing, by the cloud rendering process, the target file based on the received target file confirmation message.

According to one or more embodiments of the present disclosure, the file transmission method according to Example 7 of the present disclosure further includes the followings.

In at least one embodiments, the cloud rendering process includes a first processing service and a second processing service. The first processing service and the second processing service are communicatively connected through a predetermined intra-process communication mode. The client and the first processing service are communicatively connected through a predetermined network communication protocol. The cloud application process and the second processing service are communicatively connected through a predetermined inter-process communication mode.

According to one or more embodiments of the present disclosure, the file transmission method according to Example 8 of the present disclosure further includes the followings.

In at least one embodiments, in response to the transmitter being the cloud and the receiver being client, obtaining a target file to be transmitted includes: transmitting, by the cloud application process, a target file transmission request to the second processing service; transmitting, by the second processing service, the target file transmission request to the first processing service; and obtaining, by the first processing service, the target file to be transmitted based on a target file storage path in the received target file transmission request.

According to one or more embodiments of the present disclosure, a file transmission method according to Example 9 of the present disclosure is provided. The method can be applied to the receiver, and include: receiving, through a file transmission channel, the plurality of target file slices transmitted by a transmitter, in which the plurality of target file slices are transmitted by the transmitter in response to a target file to be transmitted being a predetermined file corresponding to the file transmission channel and after the target file is sliced; and obtaining the target file based on the received target file slices.

The file transmission channel is a transmission channel established between a client and a cloud, the cloud includes a cloud rendering process and a cloud application process, the client and the cloud rendering process are communicatively connected through a predetermined network communication protocol, and the cloud rendering process and the cloud application process are communicatively connected through a predetermined inter-process communication mode.

According to one or more embodiments of the present disclosure, the file transmission method according to Example 10 of the present disclosure further includes the followings.

In at least one embodiments, in response to the transmitter being the cloud and the receiver being the client, obtaining the target file based on the received target file slices includes: storing, by the cloud rendering process, a received target file slice into a first cache queue, and assembling the target file slices in the first cache queue after the target file slices are received, to obtain an assembled target file; storing, by the cloud rendering process, the target file to a predetermined storage location, and transmitting a file transmission success message to the cloud application process; and obtaining, by the cloud application process, the target file from the predetermined storage location based on the received file transmission success message.

According to one or more embodiments of the present disclosure, the file transmission method according to Example 11 of the present disclosure further includes the followings.

In at least one embodiments, in response to the transmitter being the cloud and the receiver being the client, obtaining the target file based on the received target file slices includes: storing, by the client, a received target file slice into a second cache queue, and assembling the target file slices in the second cache queue after the target file slices are received, to obtain an assembled target file; and storing, by the client, the target file to a predetermined storage location, to cause the client to obtain the target file from the predetermined storage location.

According to one or more embodiments of the present disclosure, a file transmission apparatus according to Example 12 of the present disclosure there is provided. The apparatus is integrated in the transmitter, and the apparatus includes: a target file obtaining module, configured to obtain a target file to be transmitted; a target file slicing module, configured to, in response to the target file being a predetermined file corresponding to a file transmission channel, slice the target file; and a file slice transmitting module, configured to transmit a plurality of sliced target file slices through the file transmission channel to cause a receiver to obtain the target file based on the received target file slices.

The file transmission channel is a transmission channel established between a client and a cloud, the cloud includes a cloud rendering process and a cloud application process. The client and the cloud rendering process are communicatively connected through a predetermined network communication protocol, and the cloud rendering process and the cloud application process are communicatively connected through a predetermined inter-process communication mode.

According to one or more embodiments of the present disclosure, a file transmission apparatus according to Example 13 of the present disclosure there is provided. The apparatus is integrated in the receiver, and the apparatus includes: a file slice receiving module, configured to receive, through a file transmission channel, the plurality of target file slices transmitted by a transmitter, in which the plurality of target file slices are transmitted by the transmitter in response to a target file to be transmitted being a predetermined file corresponding to the file transmission channel and after the target file is sliced; and a target file obtaining module, configured to obtain the target file based on the received target file slices.

The file transmission channel is a transmission channel established between a client and a cloud, the cloud includes a cloud rendering process and a cloud application process. The client and the cloud rendering process are communicatively connected through a predetermined network communication protocol, and the cloud rendering process and the cloud application process are communicatively connected through a predetermined inter-process communication mode.

The above description is merely an illustration of the preferred embodiments of the present disclosure and the principles of the application. It should be understood by those skilled in the art that the disclosure in the present disclosure is not limited to the technical solutions of the specific combination of the above technical features, and should also cover other technical solutions formed by any combination of the above technical features or their equivalent features without departing from the above disclosed concept. For example, the above features are the technical solutions formed by mutually replacing technical features disclosed in the present disclosure (but not limited to).

Further, while operations are depicted in a particular order, this should not be understood to require that these operations be performed in the illustrated particular order or in sequential order. In certain circumstances, multitasking and parallel processing may be advantageous. Likewise, while several specific implementation details are included in the discussion above, these should not be construed as limiting the scope of the present disclosure. Certain features described in the context of separate embodiments may also be implemented in combination in a single embodiment. Conversely, the various features described in the context of a single embodiment may also be implemented in a plurality of embodiments either individually or in any suitable sub-combination.

Although the present subject matter has been described in language specific to structural features and/or methodological acts, it is to be understood that the subject matter defined in the appended claims is not necessarily limited to the specific features or acts described above. Rather, the specific features and acts described above are merely exemplary forms of implementing the claims.

What is claimed is:

1. A method of file transmission, applied at a transmitter, the method comprising:
obtaining a target file to be transmitted;
in response to the target file being a predetermined file corresponding to a file transmission channel, slicing the target file, to obtain a plurality of target file slices; and
transmitting the plurality of target file slices through the file transmission channel, to cause a receiver to obtain the target file based on the received target file slices;
wherein the file transmission channel is a transmission channel established between a client and a cloud, the cloud comprises a cloud rendering process and a cloud application process, the client and the cloud rendering process are communicatively connected through a predetermined network communication protocol, and the cloud rendering process and the cloud application process are communicatively connected through a predetermined inter-process communication mode.

2. The method of claim 1, wherein the predetermined network communication protocol comprises one of:
a Hypertext Transfer Protocol or a Transmission Control Protocol based full-duplex communication protocol; and
wherein the predetermined inter-process communication mode comprises one of: a Socket communication mode, a Binder communication mode, or a broadcast communication mode.

3. The method of claim 1, wherein in response to the transmitter being the client and the receiver being the cloud, slicing the target file comprises:
transmitting a target file transmission message to the cloud rendering process, to cause the cloud rendering process to perform validity verification on the target file transmission message and feed back a target file confirmation message after successful verification; and
slicing the target file based on the received target file confirmation message.

4. The method of claim 1, wherein in response to the transmitter being the client and the receiver being the cloud, transmitting the plurality of sliced target file slices through the file transmission channel, to cause the receiver to obtain the target file based on the received target file slices comprises:
transmitting the plurality of sliced target file slices to the cloud rendering process, to cause the cloud rendering process to cause, based on the received target file slices, the cloud application process to obtain the target file.

5. The method of claim 4, wherein transmitting the plurality of sliced target file slices to the cloud rendering process comprises:
transmitting the plurality of sliced target file slices sequentially to the cloud rendering process, to cause the cloud rendering process to verify each of the received target file slices;
continuing to transmit a subsequent target file slice based on a successful slice verification message transmitted by the cloud rendering process; and
retransmitting a current target file slice based on a slice verification failure message transmitted by the cloud rendering process.

6. The method of claim 1, wherein in response to the transmitter being the cloud and the receiver being client, slicing the target file comprises:
transmitting, by the cloud rendering process, a target file transmission message to the client, to cause the client to perform validity verification on the target file transmission message and feed back a target file confirmation message after successful verification; and
slicing, by the cloud rendering process, the target file based on the received target file confirmation message.

7. The method of claim 1, wherein the cloud rendering process comprises a first processing service and a second processing service, and wherein,
the first processing service and the second processing service are communicatively connected through a predetermined intra-process communication mode;
the client and the first processing service are communicatively connected through a predetermined network communication protocol; and
the cloud application process and the second processing service are communicatively connected through a predetermined inter-process communication mode.

8. The method of claim 7, wherein in response to the transmitter being the cloud and the receiver being the client, obtaining the target file to be transmitted comprises:
transmitting, by the cloud application process, a target file transmission request to the second processing service;
transmitting, by the second processing service, the target file transmission request to the first processing service; and
obtaining, by the first processing service, the target file to be transmitted based on a target file storage path in the received target file transmission request.

9. A method of file transmission, applied at a receiver, comprising:
receiving, through a file transmission channel, a plurality of target file slices transmitted by a transmitter, wherein the plurality of target file slices are transmitted by the transmitter in response to a target file being a predetermined file corresponding to the file transmission channel and after the target file is sliced; and
obtaining the target file based on the received target file slices,
wherein the file transmission channel is a transmission channel established between a client and a cloud, the cloud comprises a cloud rendering process and a cloud application process, the client and the cloud rendering process are communicatively connected through a predetermined network communication protocol, and the cloud rendering process and the cloud application process are communicatively connected through a predetermined inter-process communication mode.

10. The method of claim 9, wherein in response to the transmitter being the client and the receiver being the cloud, obtaining the target file based on the received target file slices comprises:
storing, by the cloud rendering process, a received target file slice into a first cache queue, and assembling the target file slices in the first cache queue after the target file slices are received, to obtain an assembled target file;
storing, by the cloud rendering process, the target file to a predetermined storage location, and transmitting a file transmission success message to the cloud application process; and
obtaining, by the cloud application process, the target file from the predetermined storage location based on the received file transmission success message.

11. The method of claim 9, wherein in response to the transmitter being the cloud and the receiver being the client, obtaining the target file based on the received target file slices comprises:
storing, by the client, a received target file slice into a second cache queue, and assembling the target file slices in the second cache queue after the target file slices are received, to obtain an assembled target file; and
storing, by the client, the target file to a predetermined storage location, to cause the client to obtain the target file from the predetermined storage location.

12. An electronic device, comprising:
one or more processors; and
a storage device configured to store one or more programs;
wherein the one or more programs, when executed by the one or more processors, cause the one or more processors to perform acts comprising:
obtaining a target file to be transmitted;
in response to the target file being a predetermined file corresponding to a file transmission channel, slicing the target file, to obtain a plurality of target file slices; and
transmitting the plurality of target file slices through the file transmission channel, to cause a receiver to obtain the target file based on the received target file slices;
wherein the file transmission channel is a transmission channel established between a client and a cloud, the cloud comprises a cloud rendering process and a cloud application process, the client and the cloud rendering process are communicatively connected through a predetermined network communication protocol, and the cloud rendering process and the cloud application process are communicatively connected through a predetermined inter-process communication mode.

13. The electronic device of claim 12, wherein the predetermined network communication protocol comprises one of:
a Hypertext Transfer Protocol or a Transmission Control Protocol based full-duplex communication protocol; and
wherein the predetermined inter-process communication mode comprises one of: a Socket communication mode, a Binder communication mode, or a broadcast communication mode.

14. The electronic device of claim 12, wherein in response to the transmitter being the client and the receiver being the cloud, slicing the target file comprises:
transmitting a target file transmission message to the cloud rendering process, to cause the cloud rendering process to perform validity verification on the target file transmission message and feed back a target file confirmation message after successful verification; and
slicing the target file based on the received target file confirmation message.

15. The electronic device of claim 12, wherein in response to the transmitter being the client and the receiver being the cloud, transmitting the plurality of sliced target file slices through the file transmission channel, to cause the receiver to obtain the target file based on the received target file slices comprises:
transmitting the plurality of sliced target file slices to the cloud rendering process, to cause the cloud rendering process to cause, based on the received target file slices, the cloud application process to obtain the target file.

16. The electronic device of claim 15, wherein transmitting the plurality of sliced target file slices to the cloud rendering process comprises:
transmitting the plurality of sliced target file slices sequentially to the cloud rendering process, to cause the cloud rendering process to verify each of the received target file slices;
continuing to transmit a subsequent target file slice based on a successful slice verification message transmitted by the cloud rendering process; and
retransmitting a current target file slice based on a slice verification failure message transmitted by the cloud rendering process.

17. The electronic device of claim 12, wherein in response to the transmitter being the cloud and the receiver being client, slicing the target file comprises:
transmitting, by the cloud rendering process, a target file transmission message to the client, to cause the client to perform validity verification on the target file transmission message and feed back a target file confirmation message after successful verification; and
slicing, by the cloud rendering process, the target file based on the received target file confirmation message.

18. The electronic device of claim 12, wherein the cloud rendering process comprises a first processing service and a second processing service, and wherein,
the first processing service and the second processing service are communicatively connected through a predetermined intra-process communication mode;
the client and the first processing service are communicatively connected through a predetermined network communication protocol; and
the cloud application process and the second processing service are communicatively connected through a predetermined inter-process communication mode.

19. The file transmission method of claim 18, wherein in response to the transmitter being the cloud and the receiver being the client, obtaining the target file to be transmitted comprises:
transmitting, by the cloud application process, a target file transmission request to the second processing service;
transmitting, by the second processing service, the target file transmission request to the first processing service; and
obtaining, by the first processing service, the target file to be transmitted based on a target file storage path in the received target file transmission request.
